(19) United States
(12) Patent Application Publication
(10) Pub. No.: US 2024/0388102 A1
(43) Pub. Date: Nov. 21, 2024

(54) DISTRIBUTION APPARATUS, POWER CONTROL SYSTEM, DISTRIBUTION METHOD, AND NON-TRANSITORY COMPUTER READABLE MEDIUM

(71) Applicant: TOYOTA JIDOSHA KABUSHIKI KAISHA, Aichi-ken (JP)

(72) Inventor: Hiroshi OKI, Seto-shi (JP)

(21) Appl. No.: 18/661,708

(22) Filed: May 13, 2024

(30) Foreign Application Priority Data
May 15, 2023 (JP) 2023-080185

(51) Int. Cl. H02J 3/46; H02J 3/28; H02J 3/38

(52) U.S. Cl. CPC H02J 3/46; H02J 3/28; H02J 3/381; H02J 2203/10; H02J 2300/10

(57) ABSTRACT

A distribution apparatus includes a controller configured to acquire, for each power source in a plurality of types of power sources used in providing adjustability during a plurality of time periods, information on either a cost by time period or carbon dioxide emissions by time period, set, for each time period in the plurality of time periods, with reference to the acquired information, a ratio of use of each power source in the plurality of types of power sources in providing the adjustability as a distribution ratio, and output a setting value of the distribution ratio by time period.

### CROSS-REFERENCE TO RELATED APPLICATION

This application claims priority to Japanese Patent Application No. 2023-080185 filed on May 15, 2023, the entire contents of which are incorporated herein by reference.

### TECHNICAL FIELD

The present disclosure relates to a distribution apparatus, a power control system, a distribution method, and a distribution program.

### BACKGROUND

Patent Literature (PTL) 1 discloses an operation planning apparatus for a power plant that has power generation equipment and energy storage equipment.

PTL 2 discloses an energy management system that controls the buying and selling of grid power associated with charging and discharging of a power storage apparatus that can store grid power from the power grid and power generated by a power generation apparatus.

PTL 3 discloses a power control apparatus that selects, for each period of operation, either a charging priority operation that prioritizes a charging operation to charge a power storage apparatus with surplus power, which is the result of subtracting the power demand from the generated power of distributed power sources, over a power selling operation to output the surplus power to the power grid as sold power, or a power selling priority operation that prioritizes the power selling operation over the charging operation. The power control apparatus then performs the selected operation.

### CITATION LIST

### Patent Literature

PTL 1: JP 2021-035277 A
PTL 2: JP 2022-142957 A
PTL 3: WO 2017/094223 A1

### SUMMARY

Retail electricity providers or registered specified power transmission and distribution companies must comply with a planned value balancing system so as not to disrupt the regional power supply and demand. The planned value balancing system requires the submission of a facility operation plan for the area of jurisdiction to the OCCTO or to the representative contractor in the case of joining a balancing group. The name “OCCTO” is an abbreviation of Organization for Cross-regional Coordination of Transmission Operators. The facility operation plan is developed by the following steps: (i) forecasting power demand and solar power generation; and (ii) developing a facility operation plan that can cover the electrical energy shortfall in (i) and minimize costs.

The facility operation plan is expected to ensure an adjustability that can absorb any forecast error occurring in (i). The required adjustability to be secured during a planning period is the required adjustability for absorption of forecast errors during the planning period plus the required adjustability for DR during a DR target time. The term “DR” is an abbreviation of demand response.

It would be helpful to proportionally distribute the required adjustability to be secured during a planning period.

A distribution apparatus according to the present disclosure includes a controller configured to:
acquire, for each power source in a plurality of types of power sources used in providing adjustability during a plurality of time periods, information on either a cost by time period or carbon dioxide emissions by time period;
set, for each time period in the plurality of time periods, with reference to the acquired information, a ratio of use of each power source in the plurality of types of power sources in providing the adjustability as a distribution ratio; and
output a setting value of the distribution ratio by time period.

A distribution method according to the present disclosure includes:
acquiring, by a distribution apparatus, for each power source in a plurality of types of power sources used in providing adjustability during a plurality of time periods, information on either a cost by time period or carbon dioxide emissions by time period;
setting, by the distribution apparatus, for each time period in the plurality of time periods, with reference to the acquired information, a ratio of use of each power source in the plurality of types of power sources in providing the adjustability as a distribution ratio; and
outputting, from the distribution apparatus, a setting value of the distribution ratio by time period.

A distribution program according to the present disclosure is configured to cause a computer to execute operations, the operations including:
acquiring, for each power source in a plurality of types of power sources used in providing adjustability during a plurality of time periods, information on either a cost by time period or carbon dioxide emissions by time period;
setting, for each time period in the plurality of time periods, with reference to the acquired information, a ratio of use of each power source in the plurality of types of power sources in providing the adjustability as a distribution ratio; and
outputting a setting value of the distribution ratio by time period.

According to the present disclosure, the required adjustability to be secured during a planning period can be proportionally distributed.

### BRIEF DESCRIPTION OF THE DRAWINGS

In the accompanying drawings:

FIG. 1 is a diagram illustrating a configuration of a power control system according to an embodiment of the present disclosure;

FIG. 2 is a graph illustrating an example of required adjustability to be secured during a planning period;

FIG. 3 is a flowchart illustrating operations of a distribution apparatus according to the embodiment of the present disclosure;

FIG. 4 is a flowchart illustrating specific procedures of the process in step S9 of FIG. 3;

FIG. 5 is a diagram illustrating an example of the result of proportional distribution according to the embodiment of the present disclosure and the effects thereof on the next process; and

FIG. 6 is a flowchart illustrating a variation of the specific procedures of the process in step S9 of FIG. 3.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

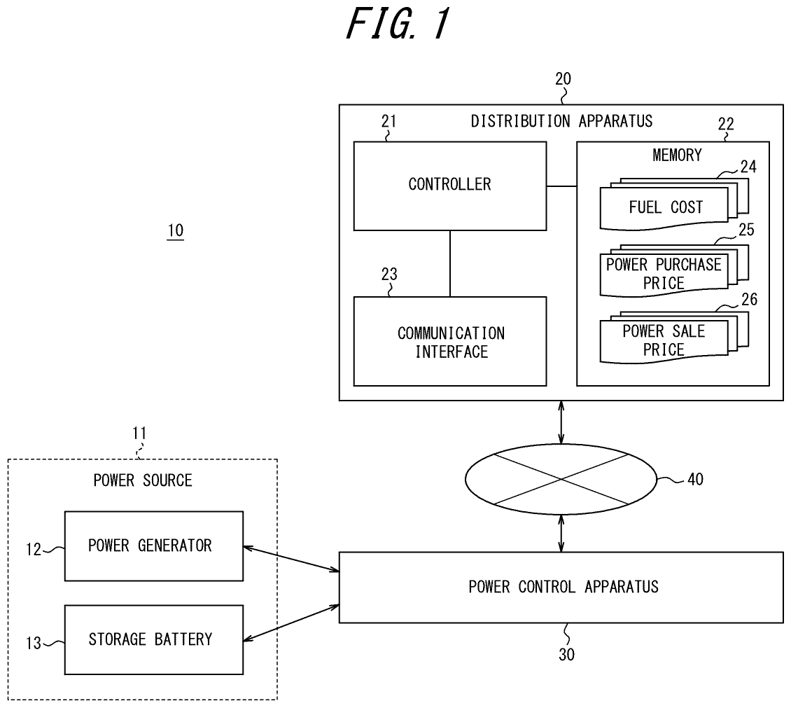

A configuration of a power control system 10 according to the present embodiment will be described with reference to FIG. 1.

The power control system 10 includes a distribution apparatus 20 and a power control apparatus 30. The distribution apparatus 20 can communicate with the power control apparatus 30 via a network 40.

The distribution apparatus 20 and the power control apparatus 30 are computers installed in facilities such as substations or data centers. The distribution apparatus 20 and the power control apparatus 30 are operated by electricity providers, such as retail electricity providers or registered specified power transmission and distribution companies.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described.

The distribution apparatus 20 acquires, for each power source 11 in a plurality of types of power sources 11 used in provision of adjustability during a plurality of time periods P, information on either a cost Ci by time period or carbon dioxide emissions Ei by time period. The “adjustability” refers to the capability of power generation facilities (including pumped storage power generation facilities), power storage apparatuses, DR, other systems that control the power supply and demand, and other equivalent facilities (excluding distribution facilities), necessary for frequency control, supply-demand balance adjustment and other grid stabilization operations in a service area. The plurality of time periods P corresponds to a planning period. The length of the planning period is, for example, 24 or 72 hours. The plurality of types of power sources 11 may include any power sources, but in the present embodiment, a power generator 12 and a storage battery 13 are included. The information on the cost Ci by time period may include information on any cost of using the plurality of types of power sources 11, but in the present embodiment, this information includes information on a fuel price 24 by time period, information on a power purchase price 25 by time period, and information on a power sale price 26 by time period.

The distribution apparatus 20 sets, for each time period Ti in the plurality of time periods P, with reference to the acquired information, a ratio of use of each power source 11 in the plurality of types of power sources 11 in providing the adjustability as a distribution ratio Di. Each time period Ti corresponds to a frame in the planning period. The length of one frame is, for example, 30 minutes.

The distribution apparatus 20 outputs the setting value of the distribution ratio Di by time period. The power control apparatus 30 controls the plurality of types of power sources 11 according to the setting value of the distribution ratio Di by time period outputted from the distribution apparatus 20.

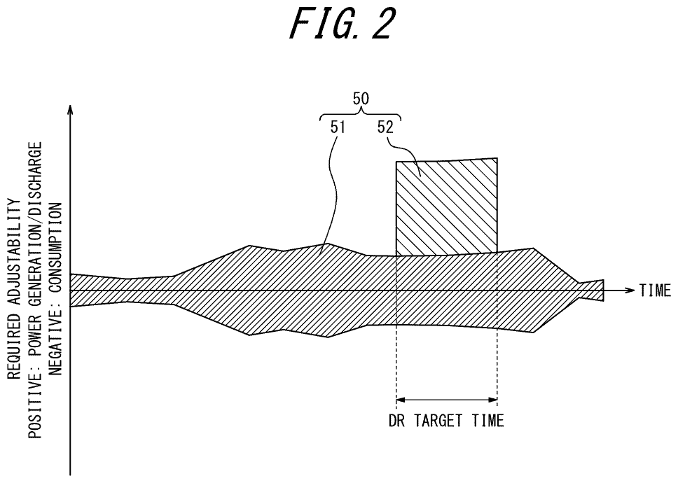

According to the present embodiment, the required adjustability 50 to be secured during a planning period can be proportionally distributed, as illustrated in FIG. 2. Specifically, in a method of proportionally distributing the required adjustability 50 to be secured during the planning period, the means of securing adjustability can be selected in the order of least unit cost or least carbon dioxide emissions.

The required adjustability 50 to be secured during a planning period is the required adjustability 51 for absorption of forecast errors during the planning period plus the required adjustability 52 for DR during the DR target time. The units are kW. The required adjustability 50 to be secured during the planning period is divided into PA and NA. The term “PA” is an abbreviation of positive adjustability. The term “NA” is an abbreviation of negative adjustability.

PA is the adjustability for procuring the lacking power due to forecast errors about power demand and solar power generation during the planning period, but PA can also include required adjustability 52 for DR during the DR target time. PA is secured in the present embodiment by leaving surplus power generation capacity in the power generator 12, by storing electricity in the storage battery 13, or both.

NA is the adjustability to absorb the surplus power resulting from forecast errors about power demand and solar power generation during the planning period. NA is secured in the present embodiment by having the power generator 12 generate power, by leaving surplus power storage capacity in the storage battery 13, or both.

A configuration of the distribution apparatus 20 according to the present embodiment will be described with reference to FIG. 1.

The distribution apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to the operations of the distribution apparatus 20 while controlling the components of the distribution apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores information to be used for the operations of the distribution apparatus 20 and information obtained by the operations of the distribution apparatus 20. In the present embodiment, the memory 22 stores at least information on either the cost Ci by time period or the carbon dioxide emissions Ei by time period.

The communication interface 23 includes at least one communication module. The communication module is, for example, a module compatible with a wired LAN communication standard such as Ethernet® (Ethernet is a registered trademark in Japan, other countries, or both) or a wireless LAN communication standard such as IEEE802.11. The name “IEEE” is an abbreviation of Institute of Electrical and Electronics Engineers. The communication interface 23 communicates with apparatuses other than the distribution apparatus 20, such as the power control apparatus 30. The communication interface 23 receives information to be used for the operations of the distribution apparatus 20 and transmits information obtained by the operations of the distribution apparatus 20. In the present embodiment, the communication interface 23 receives at least information on either the cost Ci by time period or the carbon dioxide emissions Ei by time period.

The functions of the distribution apparatus 20 are realized by execution of a distribution program according to the present embodiment by a processor serving as the controller 21. That is, the functions of the distribution apparatus 20 are realized by software. The distribution program causes a computer to execute the operations of the distribution apparatus 20, thereby causing the computer to function as the distribution apparatus 20. That is, the computer executes the operations of the distribution apparatus 20 in accordance with the distribution program to thereby function as the distribution apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the distribution apparatus 20 may be realized by a programmable circuit or a dedicated circuit serving as the controller 21. That is, some or all of the functions of the distribution apparatus 20 may be realized by hardware.

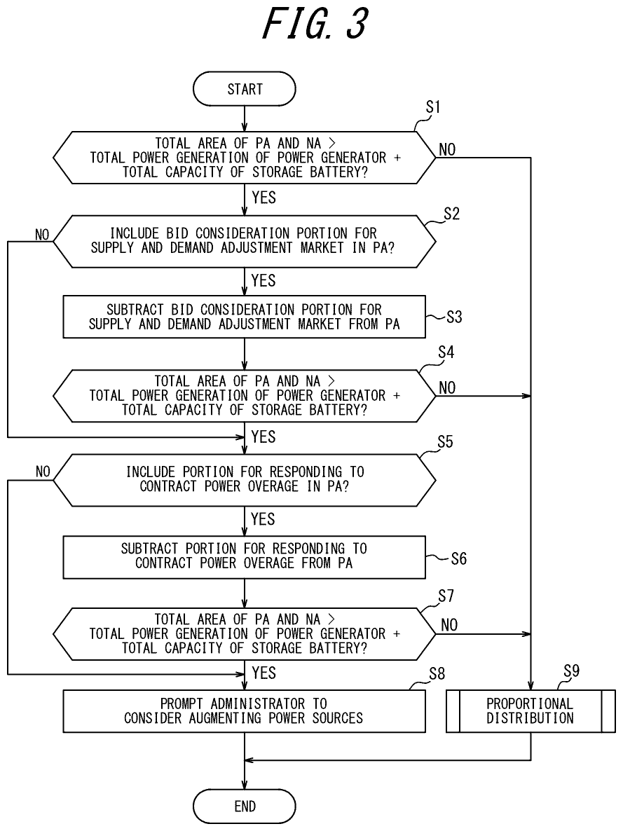

Operations of the distribution apparatus 20 according to the present embodiment will be described with reference to FIG. 3. The operations illustrated in FIG. 3 correspond to a distribution method according to the present embodiment.

In step S1, the controller 21 acquires information on the required adjustability 50 to be secured during the planning period and information on the specifications of the plurality of types of power sources 11. For example, the controller 21 receives, via the communication interface 23, information on the required adjustability 50 to be secured during the planning period and information on the specifications of the plurality of types of power sources 11 from a terminal apparatus of the administrator or an external server apparatus. Alternatively, the controller 21 may receive input of information on the required adjustability 50 to be secured during the planning period and information on the specifications of the plurality of types of power sources 11 directly from the administrator. The information on the specifications of the plurality of types of power sources 11 includes information on the specifications of the power generator 12 and information on the specifications of the storage battery 13. The controller 21 determines, with reference to the acquired information, whether the sum of PA and NA during the planning period is greater than the sum of the total power generation of the power generator 12 and the total capacity of the storage battery 13. In FIG. 2, the total area of PA and NA corresponds to the sum of PA and NA.

In a case in which the sum of PA and NA during the planning period is greater than the sum of the total power generation of the power generator 12 and the total capacity of the storage battery 13, the process in step S2 is executed. In a case in which the sum of PA and NA during the planning period is equal to or less than the sum of the total power generation of the power generator 12 and the total capacity of the storage battery 13, the process in step S9 is executed.

In step S2, the controller 21 acquires information on bid consideration for the supply and demand adjustment market. For example, the controller 21 receives, via the communication interface 23, information on bid consideration for the supply and demand adjustment market from the terminal apparatus of the administrator or from an external server apparatus. Alternatively, the controller 21 may accept input of information on bid consideration for the supply and demand adjustment market directly from the administrator. The controller 21 determines, with reference to the acquired information, whether to include the bid consideration portion for the supply and demand adjustment market in PA.

In a case of including the bid consideration portion for the supply and demand adjustment market in PA, the process in step S3 is executed. In a case of not including the bid consideration portion for the supply and demand adjustment market in PA, the process in step S5 is executed.

In step S3, the controller 21 subtracts the bid consideration portion for the supply and demand adjustment market from PA. The controller 21 may subtract only some of the bid consideration portion for the supply and demand adjustment market from PA, as long as the sum of PA and NA during the planning period can be made equivalent to the sum of the total power generation of the power generator 12 and the total capacity of the storage battery 13. The controller 21 may encourage the administrator to cancel or review the bid consideration for the supply and demand adjustment market. After step S3, the process in step S4 is executed.

In step S4, the controller 21 determines, with reference to the information acquired in step S1, whether the sum of PA and NA during the planning period is greater than the sum of the total power generation of the power generator 12 and the total capacity of the storage battery 13. PA here is the result after subtracting the bid consideration portion for the supply and demand adjustment market in step S3.

In a case in which the sum of PA and NA during the planning period is greater than the sum of the total power generation of the power generator 12 and the total capacity of the storage battery 13, the process in step S5 is executed. In a case in which the sum of PA and NA during the planning period is equal to or less than the sum of the total power generation of the power generator 12 and the total capacity of the storage battery 13, the process in step S9 is executed.

In step S5, the controller 21 acquires information on a response to contract power overage. For example, the controller 21 receives, via the communication interface 23, information on the response to contract power overage from the terminal apparatus of the administrator or from an external server apparatus. Alternatively, the controller 21 may accept input of information on the response to contract power overage directly from the administrator. The response to contract power overage is planned for cases in which contract power overage is likely to occur, such as when the reserve ratio falls below 5% as a result of power supply and demand forecasts. The controller 21 determines, with reference to the acquired information, whether to include the portion for responding to contract power overage in PA.

In a case of including the portion for responding to contract power overage in PA, the process in step S6 is executed. In a case of not including the portion for responding to contract power overage in PA, the process in step S8 is executed.

In step S6, the controller 21 subtracts the portion for responding to contract power overage from PA. The controller 21 may subtract only some of the portion for responding to contract power overage from PA, as long as the sum of PA and NA during the planning period can be made equivalent to the sum of the total power generation of the power generator 12 and the total capacity of the storage battery 13. The controller 21 may encourage the administrator to take action, such as issuing power conservation requests, to reduce power demand during the relevant time period and prevent contract power overage, so that a response to contract power overage is no longer necessary. After step S6, the process in step S7 is executed.

In step S7, the controller 21 determines, with reference to the information acquired in step S1, whether the sum of PA and NA during the planning period is greater than the sum of the total power generation of the power generator 12 and the total capacity of the storage battery 13. PA here is the result after subtracting the portion for responding to contract power overage in step S6.

In a case in which the sum of PA and NA during the planning period is greater than the sum of the total power generation of the power generator 12 and the total capacity of the storage battery 13, the process in step S8 is executed. In a case in which the sum of PA and NA during the planning period is equal to or less than the sum of the total power generation of the power generator 12 and the total capacity of the storage battery 13, the process in step S9 is executed.

In step S8, the controller 21 prompts the administrator to consider augmenting the power sources 11, such as by installing a new power generator, a new storage battery, or both. After step S8, the operations illustrated in FIG. 3 are terminated.

In step S9, the controller 21 proportionally distributes the required adjustability 50 to be secured during the planning period. Specifically, the controller 21 acquires, for each power source 11 in the plurality of types of power sources 11, information on either the cost Ci by time period or the carbon dioxide emissions Ei by time period. For example, the controller 21 receives, via the communication interface 23, information on either the cost Ci by time period or the carbon dioxide emissions Ei by time period from the terminal apparatus of the administrator or an external server apparatus. Alternatively, the controller 21 may accept input of information on either the cost Ci by time period or the carbon dioxide emissions Ei by time period directly from the administrator. The controller 21 sets, for each time period Ti in the plurality of time periods P, with reference to the acquired information, a ratio of use of each power source 11 in the plurality of types of power sources 11 in providing the adjustability as a distribution ratio Di. The controller 21 outputs the setting value of the distribution ratio Di by time period. For example, the controller 21 transmits the setting value of the distribution ratio Di by time period to the power control apparatus 30 via the communication interface 23. After step S9, the operations illustrated in FIG. 3 are terminated.

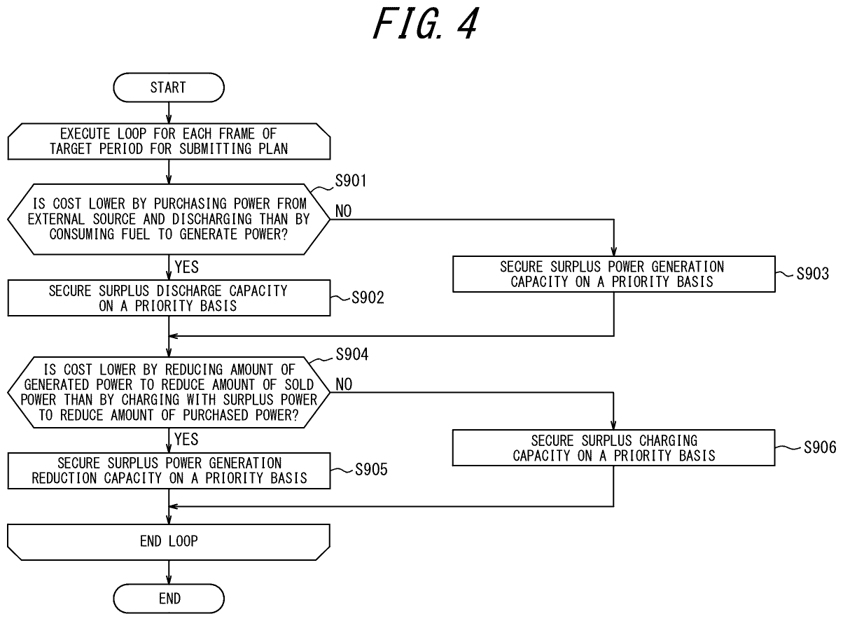

The specific procedures of the process in step S9 will be described with reference to FIG. 4.

The processes from step S901 to step S906 are executed for each time period Ti included in a plurality of time periods P, i.e., for each frame of the planning period.

In steps S901 to S903, for each time period Ti, the controller 21 sets, with reference to the information on the corresponding fuel price 24 and the information on the corresponding power purchase price 25, at least a ratio of use of each of the power generator 12 and the storage battery 13 in providing the adjustability for lacking power as the distribution ratio Di. Specifically, the controller 21 sets the ratio of use of each of the power generator 12 and the storage battery 13 in providing the adjustability for the lacking power by comparing, for each time period Ti, the cost in a case of procuring the lacking power by supplying fuel to the power generator 12 and causing the power generator 12 to generate power with the cost in a case of procuring the lacking power by supplying power obtained by purchasing power to the storage battery 13 and discharging the storage battery 13. For example, if the power generator 12 is an FC generator, the fuel is hydrogen. The term “FC” is an abbreviation of fuel cell.

More specifically, in step S901, the controller 21 compares the predicted power procurement costs in the case of generating power by consuming fuel and the case of discharging after purchasing power from an external source. In a case in which the power procurement cost is predicted to be lower by purchasing power from an external source and discharging than by consuming fuel to generate power, the controller 21 secures surplus discharge capacity of the storage battery 13 for PA on a priority basis in step S902. If the surplus discharge capacity of the storage battery 13 that can be secured for PA is insufficient after considering the amount to be secured for NA, the controller 21 also secures surplus power generation capacity of the power generator 12. For example, if ½ of the rated capacity of the storage battery 13 is secured for NA, then only up to ½ of the rated capacity of the storage battery 13 can be secured for PA. In a case in which the power procurement cost is predicted to be the same or lower by consuming fuel to generate power than by purchasing power from an external source and discharging, the controller 21 secures surplus power generation capacity of the power generator 12 for PA on a priority basis in step S903. If the surplus power generation capacity of the power generator 12 that can be secured for PA is insufficient after considering the amount to be secured for NA, the controller 21 also secures surplus discharge capacity of the storage battery 13. For example, if ½ of the rated capacity of the power generator 12 is secured for NA, then only up to ½ of the rated capacity of the power generator 12 can be secured for PA.

In steps S904 to S906, for each time period Ti, the controller 21 sets, with reference to the information on the corresponding power sale price 26 and the information on the corresponding power purchase price 25, at least a ratio of use of each of the power generator 12 and the storage battery 13 in providing the adjustability for surplus power as the distribution ratio Di. Specifically, the controller 21 sets the ratio of use of each of the power generator 12 and the storage battery 13 in providing the adjustability for the surplus power by comparing, for each time period Ti, the cost in a case of absorbing the surplus power by reducing power obtained by causing the power generator 12 to generate power for sale with the cost in a case of absorbing the surplus power by reducing power obtained by purchasing power to charge the storage battery 13.

More specifically, in step S904, the controller 21 compares the predicted power procurement costs in the case of reducing the amount of generated power to reduce the amount of sold power and the case of charging the storage battery 13 with the surplus power to reduce the amount of purchased power. In a case in which the power procurement cost is predicted to be lower by reducing the amount of generated power to reduce the amount of sold power than by charging the storage battery 13 with the surplus power to reduce the amount of purchased power, the controller 21 secures surplus power generation reduction capacity of the power generator 12 for NA on a priority basis in step S905. If the surplus power generation reduction capacity of the power generator 12 that can be secured for NA is insufficient after considering the amount to be secured for PA, the controller 21 also secures surplus charging capacity of the storage battery 13. For example, if ½ of the rated capacity of the power generator 12 is secured for PA, then only up to ½ of the rated capacity of the power generator 12 can be secured for NA. In a case in which the power procurement cost is predicted to be the same or lower by charging the storage battery 13 with the surplus power to reduce the amount of purchased power than by reducing the amount of generated power to reduce the amount of sold power, the controller 21 secures surplus charging capacity of the storage battery 13 for NA on a priority basis in step S906. If the surplus charging capacity of the storage battery 13 that can be secured for NA is insufficient after considering the amount to be secured for PA, the controller 21 also secures surplus power generation reduction capacity of the power generator 12. For example, if ½ of the rated capacity of the storage battery 13 is secured for PA, then only up to ½ of the rated capacity of the storage battery 13 can be secured for NA.

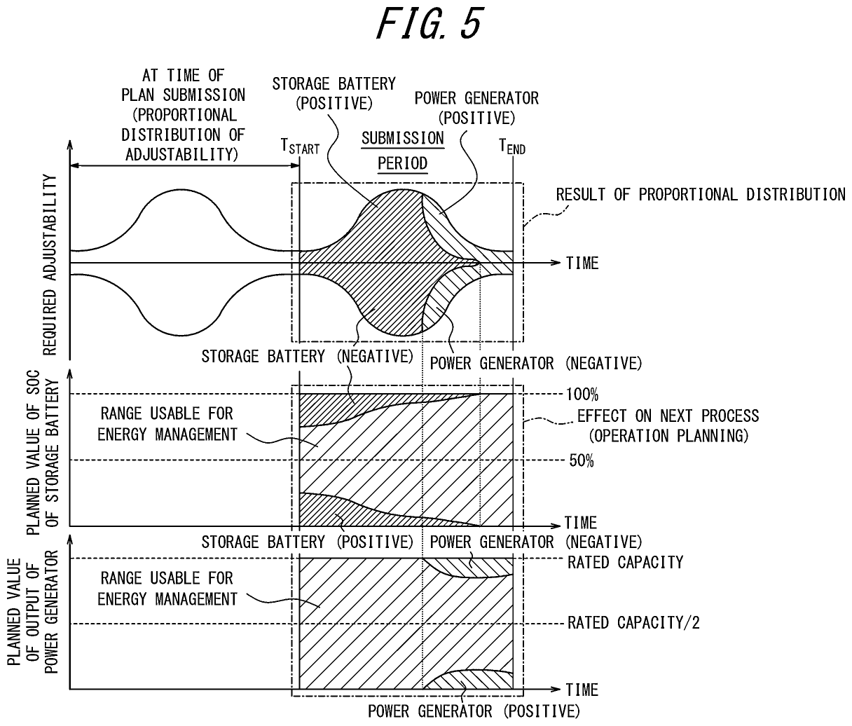

As illustrated in FIG. 4, the result of proportional distribution obtained by selecting the means for securing adjustability in the order of lowest unit cost can affect the next process. For example, as illustrated in FIG. 5, the result of proportional distribution is the upper and lower limits of the SOC of the storage battery 13, the upper and lower limits of the output of the power generator 12, or both constraints. The term “SOC” is an abbreviation of state of charge. In the example illustrated in FIG. 5, the sum of PA and NA over the planning period is smaller than the sum of the total power generation of the power generator 12 and the total capacity of the storage battery 13. Therefore, the result of subtracting the sum of PA and NA from the total power generation of the power generator 12 and the total capacity of the storage battery 13 can be used for energy management. The phrase “use for energy management” means “operate equipment according to an objective function”. For example, in a case in which the plan is created with the objective function of “minimizing power procurement costs”, the storage battery 13 is charged with the surplus of solar power generation or charged by purchasing power when power can be purchased cheaply, and the storage battery 13 is then discharged when the unit price for purchasing power is high. The power generator 12 could generate power if the above-described discharging is insufficient when the unit price for purchasing power is high, assuming that the unit price order is “purchased power>generated power>discharged power”.

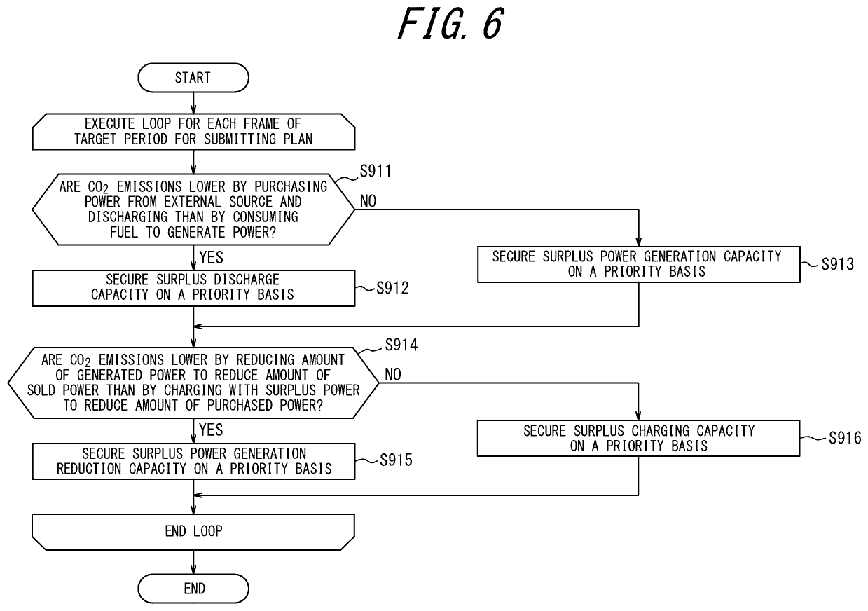

A variation of the specific procedures of the process in step S9 will be described with reference to FIG. 6.

The processes from step S911 to step S916 are executed for each time period Ti included in a plurality of time periods P, i.e., for each frame of the planning period.

In steps S911 to S913, for each time period Ti, the controller 21 sets, with reference to the information on the corresponding carbon dioxide emissions Ei, at least a ratio of use of each of the power generator 12 and the storage battery 13 in providing the adjustability for lacking power as the distribution ratio Di. Specifically, the controller 21 sets the ratio of use of each of the power generator 12 and the storage battery 13 in providing the adjustability for the lacking power by comparing, for each time period Ti, the carbon dioxide emissions in a case of procuring the lacking power by supplying fuel to the power generator 12 and causing the power generator 12 to generate power with the carbon dioxide emissions in a case of procuring the lacking power by supplying power obtained by purchasing power to the storage battery 13 and discharging the storage battery 13.

More specifically, in step S911, the controller 21 compares the predicted carbon dioxide emissions in the case of generating power by consuming fuel and the case of discharging after purchasing power from an external source. The method of calculating the carbon dioxide emissions in the case of generating power can, for example, be to calculate the carbon dioxide emissions per kWh based on the carbon dioxide emissions when fuel is burned and on the power generation efficiency, and then multiply by the amount of generated power. The method of calculating the carbon dioxide emissions in the case of purchasing power and discharging can, for example, be to multiply the carbon dioxide emissions per kWh of purchased power, which is published by each power supplier, by the amount of purchased power. In a case in which the carbon dioxide emissions are predicted to be lower by purchasing power from an external source and discharging than by consuming fuel to generate power, the controller 21 secures surplus discharge capacity of the storage battery 13 for PA on a priority basis in step S912. If the surplus discharge capacity of the storage battery 13 that can be secured for PA is insufficient after considering the amount to be secured for NA, the controller 21 also secures surplus power generation capacity of the power generator 12. In a case in which the carbon dioxide emissions are predicted to be the same or lower by consuming fuel to generate power than by purchasing power from an external source and discharging, the controller 21 secures surplus power generation capacity of the power generator 12 for PA on a priority basis in step S913. If the surplus power generation capacity of the power generator 12 that can be secured for PA is insufficient after considering the amount to be secured for NA, the controller 21 also secures surplus discharge capacity of the storage battery 13.

In steps S914 to S916, for each time period Ti, the controller 21 sets, with reference to the information on the corresponding carbon dioxide emissions Ei, at least a ratio of use of each of the power generator 12 and the storage battery 13 in providing the adjustability for surplus power as the distribution ratio Di. Specifically, the controller 21 sets the ratio of use of each of the power generator 12 and the storage battery 13 in providing the adjustability for the surplus power by comparing, for each time period Ti, the carbon dioxide emissions in a case of absorbing the surplus power by reducing power obtained by causing the power generator 12 to generate power for sale with the carbon dioxide emissions in a case of absorbing the surplus power by reducing power obtained by purchasing power to charge the storage battery 13.

More specifically, in step S914, the controller 21 compares the predicted carbon dioxide emissions in the case of reducing the amount of generated power to reduce the amount of sold power and the case of charging the storage battery 13 with the surplus power to reduce the amount of purchased power. The method of calculating the carbon dioxide emissions in the case of selling power can, for example, be to calculate the carbon dioxide emissions per kWh in the case of generating power and then multiply by the amount of sold power. In a case in which the carbon dioxide emissions are predicted to be lower by reducing the amount of generated power to reduce the amount of sold power than by charging the storage battery 13 with the surplus power to reduce the amount of purchased power, the controller 21 secures surplus power generation reduction capacity of the power generator 12 for NA on a priority basis in step S915. If the surplus power generation reduction capacity of the power generator 12 that can be secured for NA is insufficient after considering the amount to be secured for PA, the controller 21 also secures surplus charging capacity of the storage battery 13. In a case in which the carbon dioxide emissions are predicted to be the same or lower by charging the storage battery 13 with the surplus power to reduce the amount of purchased power than by reducing the amount of generated power to reduce the amount of sold power, the controller 21 secures surplus charging capacity of the storage battery 13 for NA on a priority basis in step S916. If the surplus charging capacity of the storage battery 13 that can be secured for NA is insufficient after considering the amount to be secured for PA, the controller 21 also secures surplus power generation reduction capacity of the power generator 12.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.

[Appendix 1] A distribution apparatus comprising a controller configured to:
acquire, for each power source in a plurality of types of power sources used in providing adjustability during a plurality of time periods, information on either a cost by time period or carbon dioxide emissions by time period;
set, for each time period in the plurality of time periods, with reference to the acquired information, a ratio of use of each power source in the plurality of types of power sources in providing the adjustability as a distribution ratio; and
output a setting value of the distribution ratio by time period.

[Appendix 2] The distribution apparatus according to appendix 1, wherein
the plurality of types of power sources includes a power generator and a storage battery,
the information on the cost by time period includes information on a fuel price by time period and information on a power purchase price by time period, and
the controller is configured to set, for each time period, with reference to information on a corresponding fuel price and information on a corresponding power purchase price, at least a ratio of use of each of the power generator and the storage battery in providing adjustability for lacking power as the distribution ratio.

[Appendix 3] The distribution apparatus according to appendix 2, wherein the controller is configured to set the ratio of use of each of the power generator and the storage battery in providing the adjustability for the lacking power by comparing, for each time period, a cost in a case of procuring the lacking power by supplying fuel to the power generator and causing the power generator to generate power with a cost in a case of procuring the lacking power by supplying power obtained by purchasing power to the storage battery and discharging the storage battery.

[Appendix 4] The distribution apparatus according to any one of appendices 1 to 3, wherein
the plurality of types of power sources includes a power generator and a storage battery,
the information on the cost by time period includes information on a power sale price by time period and information on a power purchase price by time period, and
the controller is configured to set, for each time period, with reference to information on a corresponding power sale price and information on a corresponding power purchase price, at least a ratio of use of each of the power generator and the storage battery in providing adjustability for surplus power as the distribution ratio.

[Appendix 5] The distribution apparatus according to appendix 4, wherein the controller is configured to set the ratio of use of each of the power generator and the storage battery in providing the adjustability for the surplus power by comparing, for each time period, a cost in a case of absorbing the surplus power by reducing power obtained by causing the power generator to generate power for sale with a cost in a case of absorbing the surplus power by reducing power obtained by purchasing power to charge the storage battery.

[Appendix 6] The distribution apparatus according to any one of appendices 1 to 5, wherein
the plurality of types of power sources includes a power generator and a storage battery, and
the controller is configured to set, for each time period, with reference to information on corresponding carbon dioxide emissions, at least a ratio of use of each of the power generator and the storage battery in providing adjustability for lacking power as the distribution ratio.

[Appendix 7] The distribution apparatus according to appendix 6, wherein the controller is configured to set the ratio of use of each of the power generator and the storage battery in providing the adjustability for the lacking power by comparing, for each time period, carbon dioxide emissions in a case of procuring the lacking power by supplying fuel to the power generator and causing the power generator to generate power with carbon dioxide emissions in a case of procuring the lacking power by supplying power obtained by purchasing power to the storage battery and discharging the storage battery.

[Appendix 8] The distribution apparatus according to any one of appendices 1 to 7, wherein
the plurality of types of power sources includes a power generator and a storage battery, and
the controller is configured to set, for each time period, with reference to information on corresponding carbon dioxide emissions, at least a ratio of use of each of the power generator and the storage battery in providing adjustability for surplus power as the distribution ratio.

[Appendix 9] The distribution apparatus according to appendix 8, wherein the controller is configured to set the ratio of use of each of the power generator and the storage battery in providing the adjustability for the surplus power by comparing, for each time period, carbon dioxide emissions in a case of absorbing the surplus power by reducing power obtained by causing the power generator to generate power for sale with carbon dioxide emissions in a case of absorbing the surplus power by reducing power obtained by purchasing power to charge the storage battery.

[Appendix 10] A power control system comprising:
the distribution apparatus according to any one of appendices 1 to 9; and
a power control apparatus configured to control the plurality of types of power sources according to the setting value of the distribution ratio by time period as outputted by the distribution apparatus.

[Appendix 11] A distribution method comprising:
acquiring, by a distribution apparatus, for each power source in a plurality of types of power sources used in providing adjustability during a plurality of time periods, information on either a cost by time period or carbon dioxide emissions by time period;
setting, by the distribution apparatus, for each time period in the plurality of time periods, with reference to the acquired information, a ratio of use of each power source in the plurality of types of power sources in providing the adjustability as a distribution ratio; and
outputting, from the distribution apparatus, a setting value of the distribution ratio by time period.

[Appendix 12] A distribution program configured to cause a computer to execute operations, the operations comprising:
acquiring, for each power source in a plurality of types of power sources used in providing adjustability during a plurality of time periods, information on either a cost by time period or carbon dioxide emissions by time period;
setting, for each time period in the plurality of time periods, with reference to the acquired information, a ratio of use of each power source in the plurality of types of power sources in providing the adjustability as a distribution ratio; and
outputting a setting value of the distribution ratio by time period.

1. A distribution apparatus comprising a controller configured to:
acquire, for each power source in a plurality of types of power sources used in providing adjustability during a plurality of time periods, information on either a cost by time period or carbon dioxide emissions by time period;
set, for each time period in the plurality of time periods, with reference to the acquired information, a ratio of use of each power source in the plurality of types of power sources in providing the adjustability as a distribution ratio; and
output a setting value of the distribution ratio by time period.

2. The distribution apparatus according to claim 1, wherein
the plurality of types of power sources includes a power generator and a storage battery,
the information on the cost by time period includes information on a fuel price by time period and information on a power purchase price by time period, and
the controller is configured to set, for each time period, with reference to information on a corresponding fuel price and information on a corresponding power purchase price, at least a ratio of use of each of the power generator and the storage battery in providing adjustability for lacking power as the distribution ratio.

3. The distribution apparatus according to claim 2, wherein the controller is configured to set the ratio of use of each of the power generator and the storage battery in providing the adjustability for the lacking power by comparing, for each time period, a cost in a case of procuring the lacking power by supplying fuel to the power generator and causing the power generator to generate power with a cost in a case of procuring the lacking power by supplying power obtained by purchasing power to the storage battery and discharging the storage battery.

4. The distribution apparatus according to claim 1, wherein
the plurality of types of power sources includes a power generator and a storage battery,
the information on the cost by time period includes information on a power sale price by time period and information on a power purchase price by time period, and
the controller is configured to set, for each time period, with reference to information on a corresponding power sale price and information on a corresponding power purchase price, at least a ratio of use of each of the power generator and the storage battery in providing adjustability for surplus power as the distribution ratio.

5. The distribution apparatus according to claim 4, wherein the controller is configured to set the ratio of use of each of the power generator and the storage battery in providing the adjustability for the surplus power by comparing, for each time period, a cost in a case of absorbing the surplus power by reducing power obtained by causing the power generator to generate power for sale with a cost in a case of absorbing the surplus power by reducing power obtained by purchasing power to charge the storage battery.

6. The distribution apparatus according to claim 1, wherein
the plurality of types of power sources includes a power generator and a storage battery, and
the controller is configured to set, for each time period, with reference to information on corresponding carbon dioxide emissions, at least a ratio of use of each of the power generator and the storage battery in providing adjustability for lacking power as the distribution ratio.

7. The distribution apparatus according to claim 6, wherein the controller is configured to set the ratio of use of each of the power generator and the storage battery in providing the adjustability for the lacking power by comparing, for each time period, carbon dioxide emissions in a case of procuring the lacking power by supplying fuel to the power generator and causing the power generator to generate power with carbon dioxide emissions in a case of procuring the lacking power by supplying power obtained by purchasing power to the storage battery and discharging the storage battery.

8. The distribution apparatus according to claim 1, wherein
the plurality of types of power sources includes a power generator and a storage battery, and
the controller is configured to set, for each time period, with reference to information on corresponding carbon dioxide emissions, at least a ratio of use of each of the power generator and the storage battery in providing adjustability for surplus power as the distribution ratio.

9. The distribution apparatus according to claim 8, wherein the controller is configured to set the ratio of use of each of the power generator and the storage battery in providing the adjustability for the surplus power by comparing, for each time period, carbon dioxide emissions in a case of absorbing the surplus power by reducing power obtained by causing the power generator to generate power for sale with carbon dioxide emissions in a case of absorbing the surplus power by reducing power obtained by purchasing power to charge the storage battery.

10. A power control system comprising:
the distribution apparatus according to claim 1; and
a power control apparatus configured to control the plurality of types of power sources according to the setting value of the distribution ratio by time period as outputted by the distribution apparatus.

11. A distribution method comprising:
acquiring, by a distribution apparatus, for each power source in a plurality of types of power sources used in providing adjustability during a plurality of time periods, information on either a cost by time period or carbon dioxide emissions by time period;
setting, by the distribution apparatus, for each time period in the plurality of time periods, with reference to the acquired information, a ratio of use of each power source in the plurality of types of power sources in providing the adjustability as a distribution ratio; and
outputting, from the distribution apparatus, a setting value of the distribution ratio by time period.

12. A non-transitory computer readable medium storing a distribution program configured to cause a computer to execute operations, the operations comprising:
acquiring, for each power source in a plurality of types of power sources used in providing adjustability during a plurality of time periods, information on either a cost by time period or carbon dioxide emissions by time period;
setting, for each time period in the plurality of time periods, with reference to the acquired information, a ratio of use of each power source in the plurality of types of power sources in providing the adjustability as a distribution ratio; and
outputting a setting value of the distribution ratio by time period.
